(19) United States
(12) Patent Application Publication
(10) Pub. No.: US 2024/0386079 A1
(43) Pub. Date: Nov. 21, 2024

(54) AUTHORIZATION SERVICE SYSTEM, NON-TRANSITORY COMPUTER READABLE MEDIUM STORING PROGRAM, AND AUTHORIZATION SERVICE METHOD

(71) Applicant: FUJIFILM Business Innovation Corp., Tokyo (JP)

(72) Inventor: Tetsuya KOBAYASHI, Kanagawa (JP)

(73) Assignee: FUJIFILM Business Innovation Corp., Tokyo (JP)

(21) Appl. No.: 18/504,159

(22) Filed: Nov. 8, 2023

(30) Foreign Application Priority Data
May 16, 2023 (JP) 2023-080578

(51) Int. Cl. G06F 21/31

(52) U.S. Cl. CPC G06F 21/31

(57) ABSTRACT

An authorization service system, in which a mobile terminal makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, the mobile terminal includes a processor configured to: in a case where the user terminal apparatus receives data set to a state where a data processing apparatus is not able to process the data as unprocessable data, make the authorization request to the authorizer by displaying the unprocessable data; acquire execution permission information to be provided in a case where the authorizer makes an authorization in response to the authorization request; and change the unprocessable data to a state where the data processing apparatus is able to process the unprocessable data by using the execution permission information.

### CROSS-REFERENCE TO RELATED APPLICATIONS

This application is based on and claims priority under 35 USC 119 from Japanese Patent Application No. 2023-080578 filed May 16, 2023.

### BACKGROUND

### (i) Technical Field

The present invention relates to an authorization service system, a non-transitory computer readable medium storing a program, and an authorization service method.

### (ii) Related Art

Cloud computing is a usage form in which computer resources are provided in the form of services via a computer network such as the Internet. In general, cloud computing is often abbreviated as “cloud”. Among the services provided by the cloud, there is a service called authorization print. In the authorization print, the user sends to the cloud, a file that the user wants to print and an authorization request for print permission from the superior. The cloud makes an authorization request to the superior, and in a case where the authorization is obtained, the cloud changes the state of the file to a printable state. Accordingly, the user moves to the printer to print and prints the authorized file.

### SUMMARY

In a case where the cloud cannot be accessed via a network, the authorization service provided by the cloud cannot be used even in a case the user wants to use the authorization service.

Aspects of non-limiting embodiments of the present disclosure relate to an authorization service system, a non-transitory computer readable medium storing a program, and an authorization service method, in which in a case where a cloud provides an authorization service for obtaining authorization from an authorizer in response to an authorization request for execution of data processing from a user, the authorization can be obtained from the authorizer even in a case where the cloud cannot be accessed.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an authorization service system, in which a mobile terminal makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, the mobile terminal includes a processor configured to: in a case where the user terminal apparatus receives data set to a state where a data processing apparatus is not able to process the data as unprocessable data, make the authorization request to the authorizer by displaying the unprocessable data; acquire execution permission information to be provided in a case where the authorizer makes an authorization in response to the authorization request; and change the unprocessable data to a state where the data processing apparatus is able to process the unprocessable data by using the execution permission information.

### BRIEF DESCRIPTION OF THE DRAWINGS

Exemplary embodiment(s) of the present invention will be described in detail based on the following figures, wherein:

FIG. 1 is an overall configuration diagram illustrating an authorization service system according to Exemplary Embodiment 1;

FIG. 2 is a functional block configuration diagram of a mobile terminal according to Exemplary Embodiment 1;

FIG. 3 is a flowchart illustrating an authorization print agency process according to Exemplary Embodiment 1;

FIG. 4 is a flowchart illustrating an authorization print agency process according to Exemplary Embodiment 2;

FIG. 5 is a flowchart illustrating an authorization print agency process according to Exemplary Embodiment 3; and

FIG. 6 is a flowchart illustrating an authorization print agency process according to Exemplary Embodiment 4.

### DETAILED DESCRIPTION

Hereinafter, an exemplary embodiment of the present invention will be described with reference to the drawings.

### Exemplary Embodiment 1

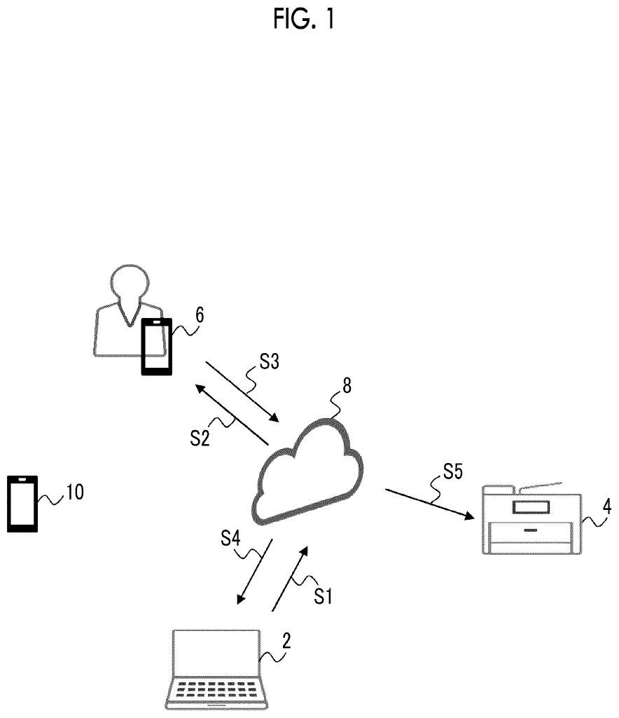

FIG. 1 is an overall configuration diagram illustrating an authorization service system according to one exemplary embodiment of the present invention. In FIG. 1, a user terminal apparatus (hereinafter, “user terminal”) 2, a printer 4, a mobile terminal 6 carried by a superior, and cloud 8 connected to each of the network devices 2, 4, and 6 via a network including the Internet. A mobile terminal 10 is a mobile terminal that can be used by the user of a user terminal 2. The mobile terminal 10 may also have a function of connecting to the Internet, but in the authorization print provided in the present exemplary embodiment, the mobile terminal 10 does not connect to the cloud 8 by using the connection function.

The user terminal 2 is an information processing apparatus used by the user, and can be implemented by an existing general-purpose hardware configuration such as a personal computer (PC), in the present exemplary embodiment. That is, the user terminal 2 uses a CPU, a ROM, a RAM, a hard disk drive (HDD) as a storage unit, a user interface including an input unit such as a mouse or a keyboard and a display unit such as a display, and a network interface for performing network communication via the Internet to use cloud service or the like as a communication unit.

The printer 4 can be implemented by an image forming apparatus such as a multifunction machine equipped with a print function, for example. The printer 4 in the present exemplary embodiment can be implemented by a general-purpose apparatus configuration having a built-in computer. That is, the printer 4 has a CPU, a ROM, a RAM, a hard disk drive (HDD) as a storage unit, an operation panel as a user interface, and a network interface as a communication unit.

The superior in the present exemplary embodiment is an authorizer who authorizes printing of a document file to be printed (hereinafter, simply referred to as “document”) in response to a request from the user of the user terminal 2. Therefore, the mobile terminal 6 carried by the superior is positioned as an authorizer terminal, and is a portable terminal apparatus such as a smartphone or a tablet terminal. Since the mobile terminal 6 has a built-in computer, the mobile terminal 6 has a CPU, a ROM, a RAM, a storage unit such as a storage, a user interface such as a touch panel, and a communication unit such as a network interface. In the present exemplary embodiment, the authorizer terminal is the mobile terminal 6, but may not have necessarily portability.

The cloud 8 is a form of a computer network system constructed by one or a plurality of computers. The cloud 8 in the present exemplary embodiment is connected to each of the network devices 2, 4, and 6 via the Internet to provide an authorization service. The authorization service is one of the cloud services provided by the cloud 8, and is a service that obtains authorization from the authorizer in response to an authorization request for execution of data processing from the user terminal 2 via a network such as the Internet. In the present exemplary embodiment, the authorization print service will be described as an example of the authorization service. Therefore, the printer 4 in the present exemplary embodiment is provided as a data processing device that executes a data process of printing data called a document.

As described above, the mobile terminal 10 is a mobile terminal that can be used by the user of the user terminal 2. Similar to the mobile terminal 6, the mobile terminal 10 can be implemented by general-purpose hardware, and may be implemented by, for example, a smartphone or a tablet terminal. However, the mobile terminal 10 includes, according to necessity, a unit that reads a data code such as a QR code (registered trademark).

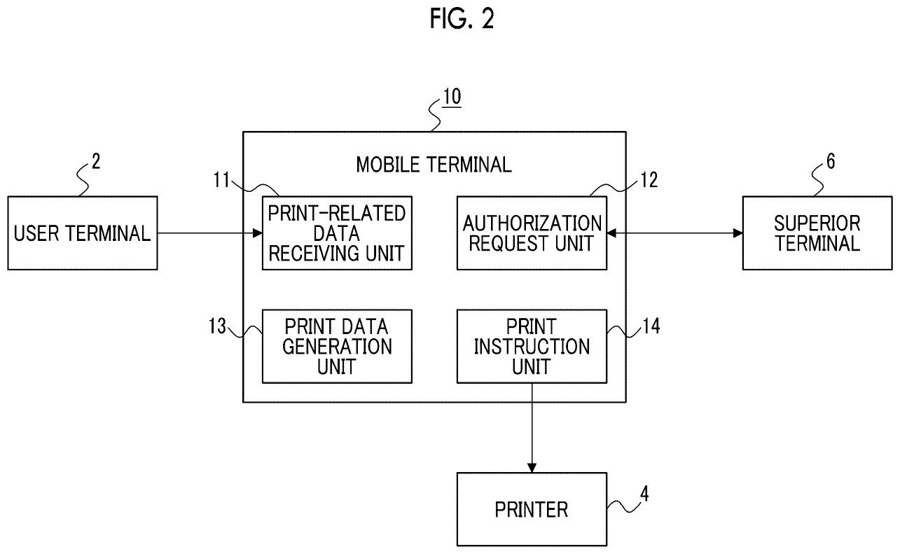

FIG. 2 is a functional block configuration diagram of the mobile terminal 10 according to the present exemplary embodiment. The mobile terminal 10 according to the present exemplary embodiment has a print-related data receiving unit 11, an authorization request unit 12, a print data generation unit 13, and a print instruction unit 14. Constituents not used in the description of the present exemplary embodiment are not illustrated in the drawings.

The print-related data receiving unit 11 receives print-related data transmitted from the user terminal 2. Although details will be described later, the print-related data includes a document that is set such that the printer 4 is unable to print, as unprocessable data. In a case where the print-related data receiving unit 11 receives the print-related data, the authorization request unit 12 requests the superior to authorize the print-related data. The print data generation unit 13 acquires execution permission information to be provided in a case where the superior performs authorization in response to the authorization request made by the authorization request unit 12, and changes the state of the unprocessable data included in the print-related data to a state where the printer 4 can print, by using the execution permission information. The print instruction unit 14 instructs the printer 4 to print the document of which state is changed to the printable state by the print data generation unit 13.

Each of the constituents 11 to 14 of the mobile terminal 10 is implemented by a cooperative operation between a computer built into the mobile terminal 10 and a program operated by a CPU mounted on the computer. By installing an application corresponding to this program in the mobile terminal 10, it is possible to execute a characteristic authorization print agency process in the present exemplary embodiment described later.

Further, the program used in the present exemplary embodiment can be provided not only by a communication unit but also by being stored in a computer-readable recording medium such as a CD-ROM or a USB memory. The programs provided by the communication unit and the recording medium are installed in the computer, and various processes are achieved by the CPU of the computer sequentially executing the programs.

The “authorization service system” in the present exemplary embodiment has the system configuration shown in FIG. 1 as an example. For example, although each of the network devices 2, 4, 6, and 10 is described as being configured by a single device, each of the network devices 2, 4, 6, and 10 may be configured by a plurality of devices. The cloud 8 is generally configured by a plurality of apparatuses, but may be configured by a single apparatus.

Next, the operation in the present exemplary embodiment will be described, and the authorization print that has been provided from the beginning will be described with reference to FIG. 1.

First, the user uploads, to the cloud 8, the document stored in the user terminal 2 and an authorization request for the print permission of the document from the superior (step S1). The document to be printed is set in a state where printing cannot be performed unless the authorization from the superior is obtained. In a case where the authorization request is sent, the cloud 8 makes an authorization request specifying a document to be authorized to the mobile terminal of the superior (hereinafter, also referred to as “superior terminal”) 6 (step S2). In a case where the superior terminal 6 replies that the superior permits the printing of the document (step S3), the cloud 8 changes the state of the document to a printable state and notifies the user terminal 2 that the printing is authorized (step S4). In a case where the authorization for printing is obtained, the user moves to the printer 4 to print, downloads the authorized document to the printer 4 to print the document (step S5).

The authorization print is executed as described above, but the authorization print cannot be executed unless the user terminal 2 can make an authorization request to the cloud 8 in step S1. Further, in a case where any of the network devices 2, 4 and 6 cannot access the cloud 8 in any of the processes of not only step S1, but also steps S2 to S5, the authorization print cannot be normally executed.

Thus, in the present exemplary embodiment, the user may be able to obtain authorization from the superior even in a case where the above-described authorization print cannot be executed because the cloud 8 cannot be accessed for some reason. Therefore, in the present exemplary embodiment, the user effectively uses and causes the mobile terminal 10 to perform the authorization print, instead of using the user terminal 2.

Strictly speaking, in a case where the service function provided by the cloud 8 is an authorization print, it is not appropriate to refer to a process performed by the mobile terminal 10 instead of the user terminal 2 because the cloud 8 cannot be accessed. However, in the present exemplary embodiment, since the mobile terminal 10 obtains the authorization for printing instead of the user terminal 2 in a case where the authorization print provided by the cloud 8 cannot be used, this process will be referred to as an “authorization print agency process”.

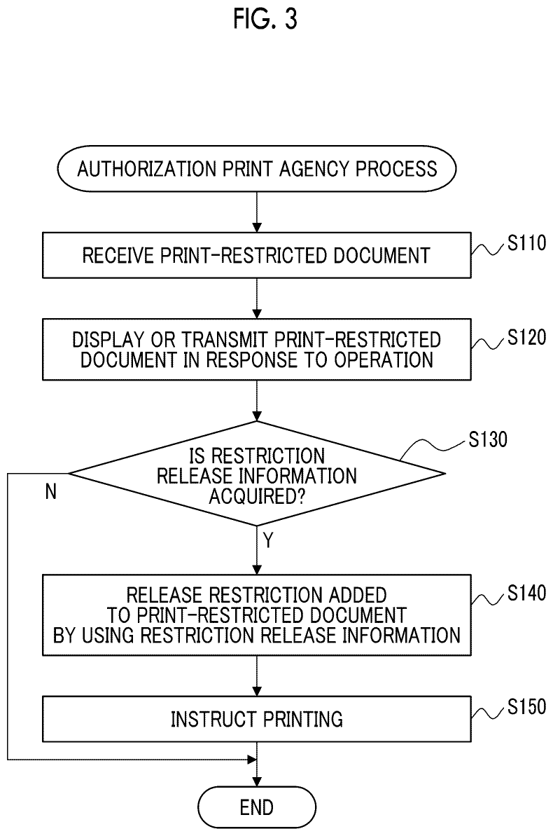

Hereinafter, an authorization print agency process by the mobile terminal 10 in the present exemplary embodiment will be described with reference to the flowchart shown in FIG. 3.

In the present exemplary embodiment as well, in a case where the cloud 8 can be accessed, the authorization print is performed via the cloud 8. However, the following description will be made based on the assumption that the authorization print via the cloud 8 cannot be executed.

In a case where the cloud 8 cannot be accessed, the user generates a document whose printing is restricted as a print-restricted document by setting the document to be printed to a state where the printer 4 cannot process the document. Then, the user terminal 2 transmits a print job including the print-restricted document to the mobile terminal 10.

A “print-restricted document” refers to a document in a state where a restriction is imposed such that printing cannot be performed in a case where restriction release information is not set. Further, in the present exemplary embodiment, the print-restricted document corresponds to the above-described unprocessable data, and may be basically created in the same manner as before. For example, in a case where printing is authorized by the superior, the cloud 8 changes the state of the print-restricted document to a state where the printer 4 can print, by releasing the restriction set for the print-restricted document uploaded based on the authorized information issued by the superior. The user terminal 2 generates the print-restricted document in the same manner as in the case where the cloud 8 can be accessed, but transmits the document to the mobile terminal 10 instead of the cloud 8. Incidentally, the print-restricted document can be displayed in a state where the contents of the document can be checked, even in a state where print cannot be performed.

In the mobile terminal 10, the print-related data receiving unit 11 receives the print job transmitted from the user terminal 2 as print-related data (step S110). Subsequently, the authorization request unit 12 displays the print-restricted document included in the received print job on the touch panel (step S120). The print-restricted documents is plain text even though the document has print restriction. A case of transmitting the print-restricted document will be described later. Here, the mobile terminal 10 is a device that can be used by the user of the user terminal 2 and can be carried by the user.

In this case, the user carries the mobile terminal 10 and moves to a place where the superior is present, and makes an authorization request to the superior by showing the print-restricted document displayed on the touch panel. In other words, the user performs a predetermined operation for displaying the print-restricted document on the mobile terminal 10, and the authorization request unit 12 makes an authorization request by displaying the print-restricted document on the touch panel in response to this operation.

In a case where the superior views the print-restricted documents displayed on the mobile terminal 10 and permits printing, the superior assigns to the mobile terminal 10, restriction release information as execution permission information used to release the restriction set on the print-restricted document. The restriction release information corresponds to the above-described authorized information issued in a case where the superior makes an authorization. For example, the superior may display code information such as a QR code (registered trademark) as restriction release information on the superior terminal 6 and cause the mobile terminal 10 to read the restriction release information. Alternatively, the superior inputs a code corresponding to the restriction release information from the code input screen redisplayed on the touch panel of the mobile terminal 10 on which the print-restricted document is displayed.

In a case where the mobile terminal 10 can acquire the restriction release information as described above (Y in step S130), the print data generation unit 13 change the state of the document to be printed to a printable state, by releasing the restriction added to the print-restricted document by using the restriction release information (step S140). For example, the print data generation unit 13 changes the state of the print-restricted document to a printable state, by making a setting such as adding restriction release information to the print-restricted document. Then, the print instruction unit 14 instructs the printer 4 to print the document by transmitting the print job including the document of which state is changed to the printable state by the print data generation unit 13 to the printer 4 (step S150).

The printer 4 in the present exemplary embodiment can print only a document for which printing restrictions have been released, and printing of the print-restricted document generated by the user terminal 2 is prohibited. For example, the printer 4 checks whether there is restriction by checking that the restriction release information is included in the header information of the document, flag information corresponding to the restriction release information is set to a flag value indicating that print is possible, and the like. Then, in a case where the document included in the print job sent from the mobile terminal 10 is in a printable state, the printer 4 executes printing.

In a case where the superior does not authorize the printing, the mobile terminal 10 ends the process because the restriction release information cannot be acquired (N in step S130).

Incidentally, in the above description, the user can move to the place where the superior is present, thereby displaying the print-restricted document on the mobile terminal 10 and obtaining authorization from the superior. However, it may be assumed that the user cannot move to the place where the superior is present, that is, a case where the user cannot show the document to the superior even after the print-restricted document is displayed on the mobile terminal 10.

Thus, in the present exemplary embodiment, in a case where the user of the user terminal 2 cannot show the print-restricted document to the superior even after the print-restricted document is displayed on the mobile terminal 10, the user performs a predetermined operation of transmitting the print-restricted document to the superior terminal 6 instead of displaying the print-restricted document on the mobile terminal 10. The authorization request unit 12 makes an authorization request by transmitting the print-restricted document to the superior terminal 6 in response to the predetermined operation (step S120). The transmission tool does not need to be particularly limited, and for example, an e-mail may be used.

The superior determines whether or not to authorize the image by displaying the print-restricted document transmitted from the mobile terminal 10 on the superior terminal 6. Then, in the case of authorization, the superior performs a predetermined operation on the superior terminal 6 to transmit the restriction release information to the mobile terminal 10. In a case where the mobile terminal 10 can receive and acquire the restriction release information from the superior terminal 6 (Y in step S130), the processes to be executed thereafter (steps S140 and S150) are the same as described above, and thus the description will be omitted.

According to the present exemplary embodiment, even in a case where the user terminal 2 or the like cannot access the cloud 8 as described above, the user can use the authorization print by causing the mobile terminal 10 to perform printing based on the authorization print function.

In the above description, the print-restricted document is changed to a printable state by adding the restriction release information acquired from the superior terminal 6 to the print-restricted document. However, after performing some conversion processes on the restriction release information acquired from the superior terminal 6, the processed restriction release information may be added to the print-restricted document.

Further, in the present exemplary embodiment, although the document authorized for printing is printed on the printer 4 from the mobile terminal 10, the document may be returned to the user terminal 2 and performed from the user terminal 2. Since the user terminal 2 is considered to have more types of print attribute settings than the mobile terminal 10, printing may be performed from the user terminal 2. This also applies to the exemplary embodiments described below.

### Exemplary Embodiment 2

In Exemplary Embodiment 1, the restriction release information that can be acquired in a case where the authorization of the superior is obtained is set in the print-restricted documents so that the printer 4 can print the document in a printable state. However, there may be a model of the printer 4 that does not have the function of determining the restriction release information. Further, the print-restricted documents is plain text even though the document is print-restricted. Therefore, the user can illegally print a document of which the restriction is not released, that is, a print-restricted document, from the printer 4 having no function of determining the restriction release information, without obtaining authorization from the superior. Thus, the present exemplary embodiment is characterized that such a case can be dealt with.

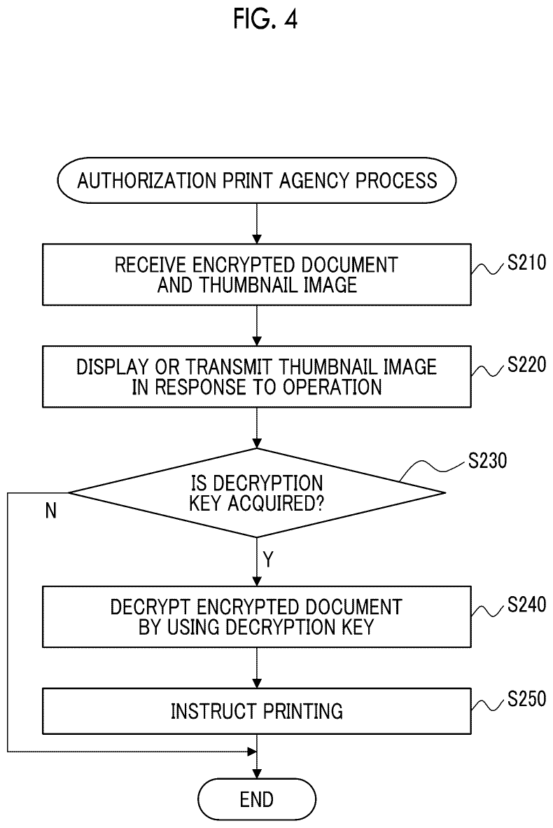

The system configuration of the authorization service system and the functional block configuration of the mobile terminal 10 in the present exemplary embodiment may be the same as in Exemplary Embodiment 1. Hereinafter, an authorization print agency process by the mobile terminal 10 in the present exemplary embodiment will be described with reference to the flowchart shown in FIG. 4. Since the basic processing flow may be the same as in Exemplary Embodiment 1, the description of common processes and actions such as operations by the user will be omitted as appropriate.

In Exemplary Embodiment 1, the print-restricted documents is created in plain text, but in the present exemplary embodiment, the user encrypts the document to be printed and then transmits the encrypted document to the mobile terminal 10. That is, the encrypted document corresponds to unprocessable data set in a state where printing cannot be performed. On the other hand, even in a case where the document is displayed on the screen by the encryption, the content of the document cannot be read correctly. Thus, the user creates an encrypted document and a thumbnail image of the document before being encrypted as substitute information, and transmits a print job including the encrypted document and the thumbnail image as a set to the mobile terminal 10. The substitute information is information that can be used to specify the document in that the content of the document can be checked by the superior, but is not a substitute for the document even in a case of being printed. Since the thumbnail image is a reduced image and it may be difficult to check the content as compared with the original text, text information or the like may be added to the thumbnail image to complement the thumbnail image.

In the mobile terminal 10, the print-related data receiving unit 11 receives the print job transmitted from the user terminal 2 as print-related data (step S210). Unlike Exemplary Embodiment 1, since the document is encrypted and is not in a plain text format, the content of the document cannot be checked even in a case where the document is printed from the printer 4 that does not support the restriction release information. Thus, the authorization request unit 12 makes an authorization request by displaying the thumbnail image included in the received print job, instead of the encrypted document, on the touch panel (step S220). A case of transmitting the thumbnail image will be described later. Here, the user makes an authorization request to the superior by displaying the thumbnail image on the screen of the mobile terminal 10 in the same manner as in Exemplary Embodiment 1.

In a case where the superior views the thumbnail image displayed on the mobile terminal 10 and permits printing, the superior operates the superior terminal 6 transmits the decryption key corresponding to the encryption key used for encryption of the encrypted document to the mobile terminal 10 as execution permission information.

In a case where the mobile terminal 10 can acquire the decryption key as described above (Y in step S230), the print data generation unit 13 decrypts the encrypted document using the decryption key to change the state of the encrypted document to a printable state (step S240). Then, the print instruction unit 14 instructs the printer 4 to print the document by transmitting the print job including the document of which state is changed to the printable state by the print data generation unit 13 to the printer 4 (step S250).

Incidentally, also in the present exemplary embodiment, similarly to Exemplary Embodiment 1, the superior may not be able to view the display screen of the mobile terminal 10. Alternatively, the content of the thumbnail image which is a reduced image may not be sufficiently checked without being brought close to the mobile terminal 10. In the present exemplary embodiment, assuming such a case, the authorization request unit 12 makes an authorization request by transmitting the thumbnail image to the superior terminal 6 in response to a predetermined operation by the user (step S220).

The superior can check the content of the document by displaying the thumbnail image transmitted from the mobile terminal 10 on the superior terminal 6. In this way, whether or not to authorize the printing of the document is determined. Then, in the case of authorization, the superior performs a predetermined operation on the superior terminal 6 to transmit the decryption key to the mobile terminal 10. In a case where the mobile terminal 10 can receive and acquire the decryption key as the execution permission information from the superior terminal 6 (Y in step S230), subsequent processes may be the same as described above, and thus the description will be omitted. In a case where the decryption key cannot be acquired (N in step S230), the mobile terminal 10 ends the process.

According to the present exemplary embodiment, by encrypting the document as described above, it is possible to prevent the document from being illegally printed from the printer 4 that does not support the restriction release information. Further, by using the thumbnail image, the content of the document can be checked by the superior, and even in a case where the thumbnail image is printed, the printed matter is not a substitute for the printed matter of the legitimate document to be printed.

### Exemplary Embodiment 3

In step S120 of FIG. 3 in Exemplary Embodiment 1, an authorization request is made by displaying or transmitting a print-restricted document. In a case where the user makes an authorization request by displaying the print-restricted document on the mobile terminal 10, since the user who wants to receive the authorization presents the mobile terminal 10 to the superior, the superior can check who makes the authorization request. On the other hand, in a case where the print-restricted document is transmitted to the superior terminal 6, the superior cannot determine the validity of the sender. That is, there is a possibility that a third party, not the user of the user terminal 2, obtains illegally the authorization for printing the document. Thus, in the present exemplary embodiment, by adding a function capable of verifying the identity of a user who intends to receive authorization, a fraudulent act that may occur in a case where an authorization request is made by transmitting a print-restricted documents to a superior can be avoided in advance. In addition, assuming that the authorization request is made by transmitting information to the superior terminal 6, it is not necessary to provide portability to the terminal device used by the user as the mobile terminal 10.

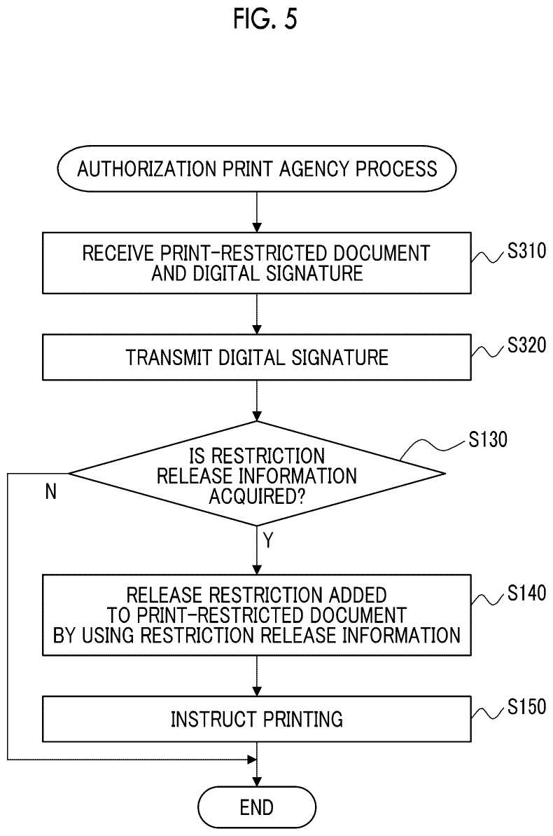

The system configuration of the authorization service system and the functional block configuration of the mobile terminal 10 in the present exemplary embodiment may be the same as in Exemplary Embodiment 1. Hereinafter, an authorization print agency process by the mobile terminal 10 in the present exemplary embodiment will be described with reference to the flowchart shown in FIG. 5. Since the basic processing flow may be the same as in Exemplary Embodiment 1, the description of common processes and actions such as operations by the user will be omitted as appropriate.

In the present exemplary embodiment, the private key and the public key assigned to the user of the user terminal 2 are used. Then, it is assumed that the superior has the public key in advance.

The user generates a print-restricted document of the document to be printed in the same manner as in Exemplary Embodiment 1. In the case of the present exemplary embodiment, further, a print-restricted document is digitally signed by using the private key assigned to the user. Then, the user terminal 2 transmits a print job including the print-restricted document and the digital signature to the mobile terminal 10.

In the mobile terminal 10, the print-related data receiving unit 11 receives the print job transmitted from the user terminal 2 as print-related data (step S310). Subsequently, the authorization request unit 12 transmits the print-restricted document and the digital signature included in the received print job to the superior terminal 6 (step S320).

In a case where the print-restricted document and the digital signature are transmitted from the mobile terminal 10, the superior terminal 6 authenticates the user himself/herself by performing signature verification using the public key of the user acquired in advance from the user who intends to receive the authorization. As this authentication technique, an existing technique may be used.

In a case where the personal authentication is successful, the superior determines whether or not to authorize the image by displaying the print-restricted document transmitted from the mobile terminal 10 on the superior terminal 6. Then, in the case of authorization, the superior performs a predetermined operation on the superior terminal 6 to transmit the restriction release information to the mobile terminal 10.

In a case where the mobile terminal 10 can receive and acquire the restriction release information from the superior terminal 6 (Y in step S130), subsequent processes (steps S140 and S150) may be the same as in Exemplary Embodiment 1, and thus the description will be omitted.

According to the present exemplary embodiment, the superior can perform identity verification and can check the content of the document in the same size as the unreduced original text.

### Exemplary Embodiment 4

In Exemplary Embodiment 1 and Exemplary Embodiment 3, the print-restricted document is used as unprocessable data, and in Exemplary Embodiment 3, identity verification can be performed by using the private key and the public key. In the present exemplary embodiment, the encrypted document described in Exemplary Embodiment 2 is used as unprocessable data, and a function of performing identity verification by using the private key and the public key as in Exemplary Embodiment 3 is added in the present exemplary embodiment.

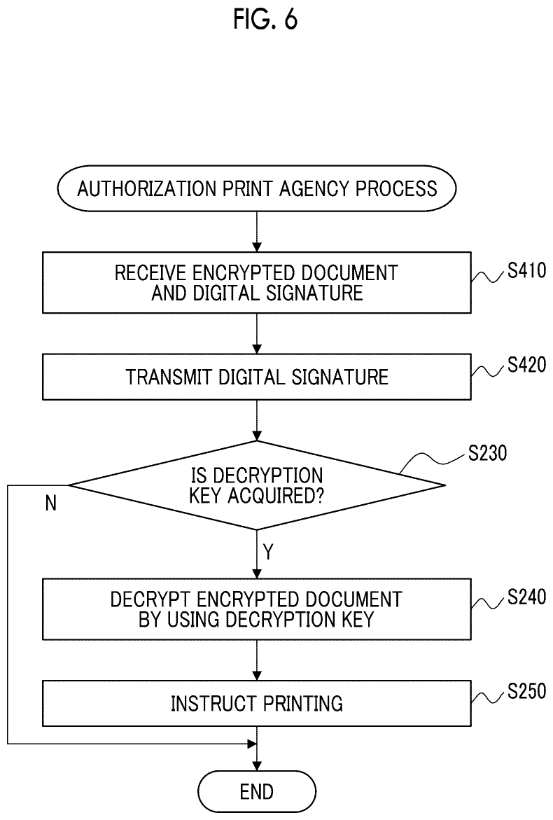

The system configuration of the authorization service system and the functional block configuration of the mobile terminal 10 in the present exemplary embodiment may be the same as in Exemplary Embodiment 1. Hereinafter, an authorization print agency process by the mobile terminal 10 in the present exemplary embodiment will be described with reference to the flowchart shown in FIG. 6. Since the basic processing flow may be the same as in Exemplary Embodiment 2, the description of common processes and actions such as operations by the user will be omitted as appropriate.

The user generates an encrypted document and a thumbnail image of the document to be printed in the same manner as in Exemplary Embodiment 1. In the case of the present exemplary embodiment, further, the encrypted document is digitally signed by using the private key assigned to the user. The thumbnail image may be the target of the digital signature. Then, the user terminal 2 transmits the print job including the encrypted document, the thumbnail image, and the digital signature to the mobile terminal 10.

In the mobile terminal 10, the print-related data receiving unit 11 receives the print job transmitted from the user terminal 2 as print-related data (step S410). Subsequently, the authorization request unit 12 transmits the encrypted document, the thumbnail image, and the digital signature included in the received print job to the superior terminal 6 (step S420).

In a case where the encrypted document, the thumbnail image, and the digital signature are transmitted from the mobile terminal 10, the superior terminal 6 authenticates the user himself/herself by performing signature verification using the public key of the user acquired in advance from the user who intends to receive the authorization. As this authentication technique, an existing technique may be used.

In a case where the personal authentication is successful, the superior determines whether or not to authorize the image by displaying the thumbnail image transmitted from the mobile terminal 10 on the superior terminal 6. Then, in the case of authorization, the superior performs a predetermined operation on the superior terminal 6 to transmit the decryption key to the mobile terminal 10.

In a case where the mobile terminal 10 can receive and acquire the decryption key from the superior terminal 6 (Y in step S230), subsequent processes (steps S240 and S250) may be the same as in Exemplary Embodiment 2, and thus the description will be omitted.

According to the present exemplary embodiment, the superior can perform identity verification and can check the content of the document on a thumbnail image.

In each of the above exemplary embodiments, a case where the authorization service provided by the cloud 8 is an authorization print service has been described as an example. However, the authorization service provided by the cloud 8 does not have to be limited to the authorization print service. That is, the authorization service may be applied to an authorization service for causing a data processing apparatus to execute a process other than printing, such as scanning.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

### Supplementary Notes

(((1))

An authorization service system in which a mobile terminal makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, the mobile terminal comprising:
a processor configured to:
   in a case where the user terminal apparatus receives data set to a state where a data processing apparatus is not able to process the data as unprocessable data, make the authorization request to the authorizer by displaying the unprocessable data;
   acquire execution permission information to be provided in a case where the authorizer makes an authorization in response to the authorization request; and
   change the unprocessable data to a state where the data processing apparatus is able to process the unprocessable data by using the execution permission information.
      (((2)))

The authorization service system according to (((1))), wherein the processor is configured to:
change the unprocessable data to a state where the unprocessable data is able to be executed by the data processing apparatus capable of processing data for which the execution permission information is set, by setting the acquired execution permission information to the unprocessable data.
   (((3)))

The authorization service system according to (((2))), wherein the processor is configured to:
acquire the execution permission information by reading code information presented by the authorizer by using a reading unit included in the mobile terminal.
   (((4)))

The authorization service system according to (((1))), wherein the processor is configured to:
in a case where the unprocessable data is encrypted data, and the unprocessable data and substitute information for specifying the data are received from the user terminal apparatus, make the authorization request to the authorizer by displaying the substitute information instead of the unprocessable data;
acquire a decryption key corresponding to an encryption key used for encrypting the unprocessable data as the execution permission information; and
change the unprocessable data to a state where the unprocessable data is able to be processed by the data processing apparatus, by decrypting the unprocessable data with the decryption key.
   (((5))

The authorization service system according to (((4))),
wherein the substitute information is a reduced image of the data before being encrypted.
   (((6)))

The authorization service system according to any one of (((1))) to (((5))), wherein the processor is configured to:
make the authorization request by transmitting the unprocessable data to an authorizer terminal used by the authorizer instead of displaying the unprocessable data; and
receive and acquire the execution permission information from the authorizer terminal in a case where the authorizer makes an authorization in response to the authorization request.
   (((7)))

The authorization service system according to any one of (((1))) to (((6))), wherein the processor is configured to:
in a case where the authorizer has a public key corresponding to a private key assigned to a user of the user terminal apparatus, transmit the unprocessable data encrypted using the private key to the authorizer terminal.
   (((8)))

The authorization service system according to any one of (((1))) to (((7))),
wherein the authorization service is an authorization print service, and
the data processing apparatus is a printing apparatus.
   (((9)))

A non-transitory computer readable medium storing a program causing a computer that makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, to execute:
a function of, in a case where the user terminal apparatus receives data set to a state where a data processing apparatus is not able to process the data as unprocessable data, making the authorization request to the authorizer by displaying the unprocessable data;
a function of acquiring execution permission information to be provided in a case where the authorizer makes an authorization in response to the authorization request; and
a function of changing the unprocessable data to a state where the data processing apparatus is able to process the unprocessable data by using the execution permission information.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An authorization service system in which a mobile terminal makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, the mobile terminal comprising:
a processor configured to:
in a case where the user terminal apparatus receives data set to a state where a data processing apparatus is not able to process the data as unprocessable data, make the authorization request to the authorizer by displaying the unprocessable data;
acquire execution permission information to be provided in a case where the authorizer makes an authorization in response to the authorization request; and
change the unprocessable data to a state where the data processing apparatus is able to process the unprocessable data by using the execution permission information.

2. The authorization service system according to claim 1, wherein the processor is configured to:
change the unprocessable data to a state where the unprocessable data is able to be executed by the data processing apparatus capable of processing data for which the execution permission information is set, by setting the acquired execution permission information to the unprocessable data.

3. The authorization service system according to claim 2, wherein the processor is configured to:
acquire the execution permission information by reading code information presented by the authorizer by using a reading unit included in the mobile terminal.

4. The authorization service system according to claim 1, wherein the processor is configured to:
in a case where the unprocessable data is encrypted data, and the unprocessable data and substitute information for specifying the data are received from the user terminal apparatus, make the authorization request to the authorizer by displaying the substitute information instead of the unprocessable data;
acquire a decryption key corresponding to an encryption key used for encrypting the unprocessable data as the execution permission information; and
change the unprocessable data to a state where the unprocessable data is able to be processed by the data processing apparatus, by decrypting the unprocessable data with the decryption key.

5. The authorization service system according to claim 4,
wherein the substitute information is a reduced image of the data before being encrypted.

6. The authorization service system according to claim 1, wherein the processor is configured to:
make the authorization request by transmitting the unprocessable data to an authorizer terminal used by the authorizer instead of displaying the unprocessable data; and
receive and acquire the execution permission information from the authorizer terminal in a case where the authorizer makes an authorization in response to the authorization request.

7. The authorization service system according to claim 6, wherein the processor is configured to:
in a case where the authorizer has a public key corresponding to a private key assigned to a user of the user terminal apparatus, transmit the unprocessable data encrypted using the private key to the authorizer terminal.

8. The authorization service system according to claim 1,
wherein the authorization service is an authorization print service, and
the data processing apparatus is a printing apparatus.

9. The authorization service system according to claim 2,
wherein the authorization service is an authorization print service, and
the data processing apparatus is a printing apparatus.

10. The authorization service system according to claim 3,
wherein the authorization service is an authorization print service, and
the data processing apparatus is a printing apparatus.

11. The authorization service system according to claim 4,
wherein the authorization service is an authorization print service, and
the data processing apparatus is a printing apparatus.

12. The authorization service system according to claim 5,
wherein the authorization service is an authorization print service, and
the data processing apparatus is a printing apparatus.

13. The authorization service system according to claim 6,
wherein the authorization service is an authorization print service, and
the data processing apparatus is a printing apparatus.

14. The authorization service system according to claim 7,
wherein the authorization service is an authorization print service, and
the data processing apparatus is a printing apparatus.

15. A non-transitory computer readable medium storing a program causing a computer that makes an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, to execute:
a function of, in a case where the user terminal apparatus receives data set to a state where a data processing apparatus is not able to process the data as unprocessable data, making the authorization request to the authorizer by displaying the unprocessable data;
a function of acquiring execution permission information to be provided in a case where the authorizer makes an authorization in response to the authorization request; and
a function of changing the unprocessable data to a state where the data processing apparatus is able to process the unprocessable data by using the execution permission information.

16. An authorization service method of making an authorization request instead of a user terminal apparatus in a case where the user terminal apparatus is not able to connect to a cloud via a network, in a case where the cloud provides an authorization service for obtaining authorization from an authorizer in response to the authorization request for execution of data processing via the network from the user terminal apparatus, the method comprising:
in a case where the user terminal apparatus receives data set to a state where a data processing apparatus is not able to process the data as unprocessable data, making the authorization request to the authorizer by displaying the unprocessable data;
acquiring execution permission information to be provided in a case where the authorizer makes an authorization in response to the authorization request; and
changing the unprocessable data to a state where the data processing apparatus is able to process the unprocessable data by using the execution permission information.
